(19) United States
(12) Patent Application Publication
(10) Pub. No.: US 2025/0059878 A1
(43) Pub. Date: Feb. 20, 2025

(54) Cement Detecting Device

(71) Applicant: Youngquist Brothers, Inc., Fort Myers, FL (US)

(72) Inventor: Harvey Bruce Youngquist, Fort Myers, FL (US)

(21) Appl. No.: 18/806,097

(22) Filed: Aug. 15, 2024

Related U.S. Application Data
(60) Provisional application No. 63/519,617, filed on Aug. 15, 2023.

(51) Int. Cl. E21B 47/005; E21B 33/13; G01V 5/12

(52) U.S. Cl. CPC E21B 47/005; E21B 33/13; G01V 5/12

(57) ABSTRACT

A system and method for measuring the level of cement in a well. A gamma ray logging device is lowered into the wellbore and positioned proximate to an interior wall of the well casing at a desired depth in the well. The gamma ray logging device is connected to a computer at the surface via a wire. The gamma ray logging device detects, and transmits to the computer, the level of gamma rays. Cement is pumped into the well. When the level of the cement gets near the gamma ray logging device, the gamma ray logging device detects a spike in gamma rays, which instructs the operator that the level of cement has reached the depth of the gamma ray logging device. The operation stops pumping cement when the gamma ray device detects a spike in gamma rays. The gamma ray logging device is raised to a new desired depth, and the process is repeated until the operation is done pumping cement.

### CROSS-REFERENCES TO RELATED APPLICATIONS

This application claims the benefit of the filing date of provisional patent application No. 63/519,617 filed Aug. 15, 2023.

### STATEMENT REGARDING FEDERALLY SPONSORED RESEARCH OR DEVELOPMENT

Not applicable.

### BACKGROUND OF THE INVENTION

### 1. Field of the Invention

The present invention relates to the drilling of subterranean wells. More specifically, the present invention relates to a device and method for detecting the level of cement when pressure grouting or tremie grouting during construction of a well.

### 2. Description of the Related Art

There are many reasons it is necessary to know, with as much accuracy as possible, the level of cement during well construction.

When tremie grouting, it is important to keep the bottom of the tremie tubing in the cement. If the tremie tubing gets above the cement, the tubing will bridge off and there will be voids in the cement. Knowing the level of cement helps avoid letting the end of the tremie tubing get above the level of cement.

When pumping cement, some intervals “drink” the cement and there will be no lift in the cement. In other words, the cement will not be at as high a level as predicted and needed. In this case it is important to keep the tubing in place and continue pumping. Cement drinking also contributes to the build-up of pressure differentials which can jeopardize the structural integrity of a casing. By closely and accurately monitoring the level of cement, the operator has a better idea whether differential pressure is building up, which reduces the risk the casing collapsing.

Prior grouting methods of detecting the level of cement inside a well required the operator to pump cement without knowing the exact level of the cement. Operators would pump a predetermined volume of cement with the expectation that it would go up to the desired level in the well. The operator would then wait approximately twelve hours for the cement to dry, then try to tag it with pipe for a physical measurement. Often, the formation would drink cement and the level the cement reached would not be as high as planned.

### BRIEF SUMMARY OF THE INVENTION

The present invention is an improved system and method for detecting the level of cement inside a well having a steel or fiberglass casing. A gamma ray logging device is lowered downhole to a specific depth. Cement is pumped into the well via cement tubing, starting at a location below the gamma ray device. When the level of cement reaches the location of the gamma ray device, the gamma ray device will measure a spike in gamma rays, notifying the operator that the level of cement has reached the location of the gamma ray device. The gamma ray device is then raised to a higher position within the casing. More cement is pumped into the hole, until the gamma ray device again detects a spike in gamma rays. The process can be repeated as necessary until the cementing is complete.

### BRIEF DESCRIPTION OF THE SEVERAL VIEWS OF THE DRAWINGS

FIG. 1 is a dioramic view of an embodiment of the cement detection system.

FIG. 2 is a second dioramic view of an embodiment of the cement detection system.

FIG. 3 is a partial detailed view of the gamma ray logging device.

FIG. 4 is a partial detailed view of the gamma ray logging device.

FIG. 5 is an environmental surface view of the cement detection system.

### DETAILED DESCRIPTION OF THE INVENTION

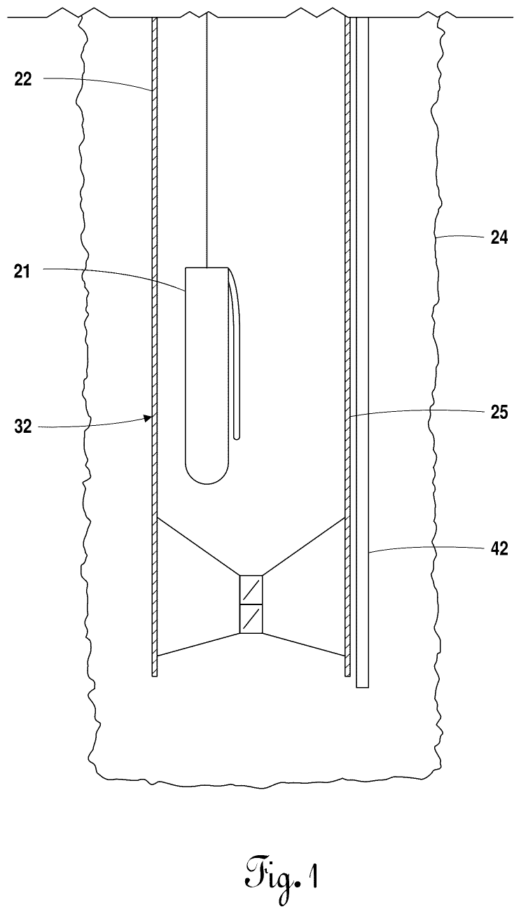

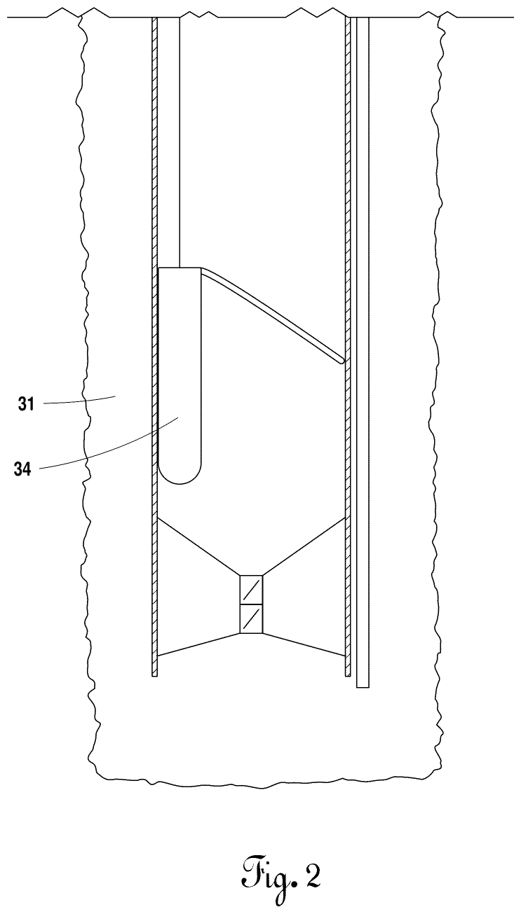

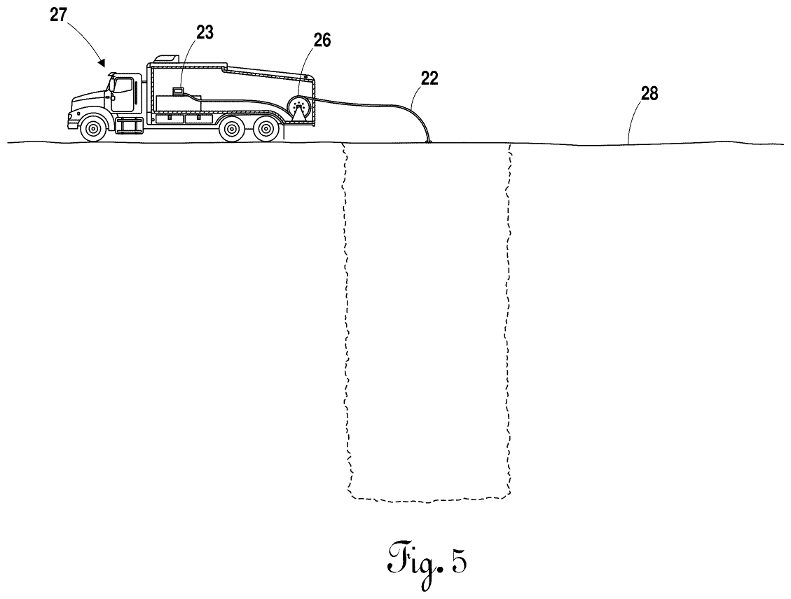

A first embodiment of the cement detecting system 20 is described with reference to FIGS. 1-2 and 5.

The cement detecting system 20 comprises a gamma ray geophysical logging device 21, a wire 22, and a computer 23.

The gamma ray geophysical logging device 21 is connected to one end of the wire. The gamma ray geophysical logging device is lowered into a bore hole 24 set with a steel or fiberglass casing 25 via the wire 22.

The other end of the wire 22 is connected to a drum 26 in a logging truck 27 on the surface 28. The wire 22 is connected to a computer 23 on the surface 28. In one embodiment, the computer 23 is housed in the logging truck 27. The logging truck 27 could be a box truck, pickup truck, trailer, or other suitable structure for housing the wire 22 and computer 23.

The connection between the wire 22 and the computer 23 electronically connects the gamma ray geophysical logging device 21 and the computer 23. The computer 23 receives and displays data 30 collected by the geophysical logging device 21. Alternative surface set ups could be used, so long as the gamma ray logging device 21 is able to transmit data 30 to the surface. Preferably, the gamma ray logging device 21 is connected to a computer 23 which can receive and display data 30 collected by the gamma ray logging device 21 and present the data 30 in a screen readable format to the user.

In operation, the gamma ray logging device 21 is placed into an offset position inside the casing 25. More specifically, the gamma ray logging device 21 is offset so that the device 21 is closer to the interior wall of the casing 25 than the central axis of the casing 25.

The gamma ray logging device 21 has an open position 31 and a closed position 32. When the gamma ray login device 21 is in the open position 31, an arm 33 of the gamma ray logging device causes a first member 34 of the gamma ray logging device 21 to move towards the interior wall of the casing 25. The first member 34 of the gamma ray device 21 is pushed outward by the arm 33 until the first member 34 is in close proximity to the interior wall of the casing 25. The gamma ray logging device 21 is more accurate when a portion of the device 21 is as close to the casing 25 as possible. The gamma ray logging device 21 can be touching the interior of the casing 25. Thus, the offset and positioning of the device 21 near the interior of the casing 25 increases the accuracy of the gamma ray logging device 21.

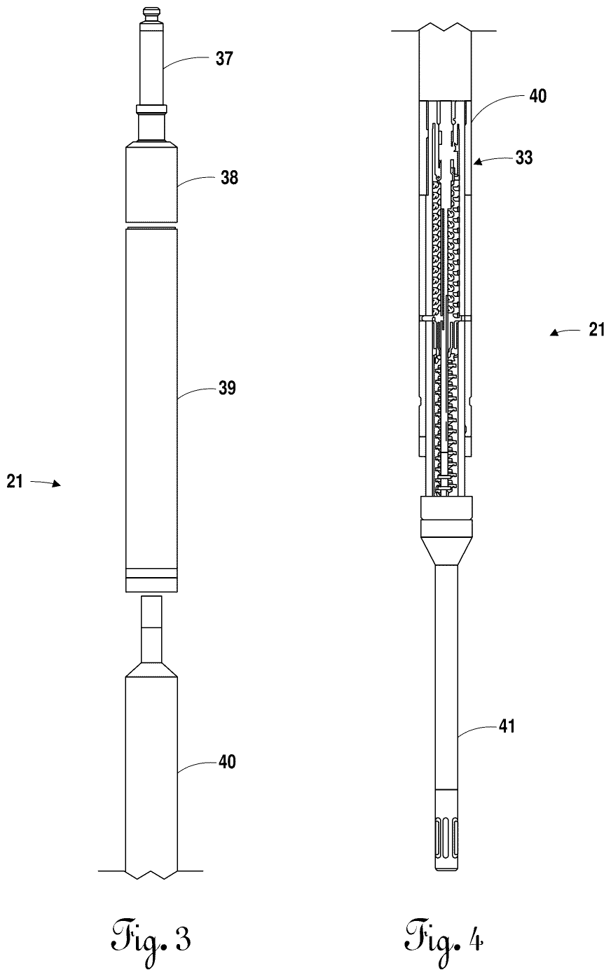

Referring to FIGS. 3 and 4, the gamma ray logging device comprises a cable head adapter 37, a cable head to gamma ray adapter 38, a gamma ray crystal and protective housing 39, an offsetting arm 40, and a temperature tool 41. The gamma ray crystal and protective housing 39 is the portion of the gamma ray logging device 21 that detects gamma rays and acts as the first member of the gamma ray tool 34. The offsetting arm 40 portion of the gamma ray logging device 21 acts as the arm 33 of the gamma ray logging device 21.

Operation of the cement detecting system 20 is described with reference to FIGS. 1-2 and 5.

The gamma ray logging tool 21 is lowered into a casing 25 within a borehole 24 to a desired depth 35. The operator tracks the depth of the gamma ray logging tool 21 using markings on the wire 22 or other suitable measuring devices. Once the gamma ray logging device 21 is at the desired depth, the operator records the depth of the gamma ray device 21. The gamma ray logging device 21 is moved into its open position 31, wherein the arm 33 of the gamma ray logging device 21 pushes the first member of the gamma ray logging device 34 towards and interior wall of the casing 25. In the open position 31, the first member 34 of the gamma ray logging device is proximate the interior wall of the casing 25.

The gamma ray logging device 21 is powered on and begins detecting natural gamma radiation in the formation. The gamma ray logging device 21 transmits the data 30 it collects to a computer 23 on the surface.

Cement is pumped into the well via cement tubing 42.

When cement reaches the level of the gamma ray logging device 21, the amount of natural gamma radiation being detected spikes. The computer 23 displays the data in in American Petroleum Institute (API) units, or other suitable units. When the gamma ray device 21 reports a spike in API, the operator knows the cement has reached the previously recorded depth of the gamma ray logging device 21.

The exact amount of API spike necessary to show the presence of cement varies based on the formation. In preliminary testing, the API when cement was not detected fluctuated between 1-3 API, then spiked to 5-10 API when cement was detected. However, testing showed a clear pattern of API spiking whenever cement reached the level of the gamma ray logging device 21.

Once cement is detected, the gamma ray logging device 21 is raised to a higher position in the well. The process can be repeated as the grouting process is continued. For example, if the operator started cementing at 1000 feet, the tremie tubing would be at 1000 feet and the logging tool would be at 950 feet. The tool would start recording data when the cement pump starts. When the level of cement reaches 950 feet the API counts would spike on the gamma ray tool. The operator then knows the cement has reached 950 feet. The operator raises the logging tool 21 up 50 feet to 900 feet, and continues pumping cement. When the API counts spike again, the operator knows the cement has reached 900 feet. The process can be repeated over and over again until grouting is completed.

1. A system for detecting the level of cement in a well comprising:
a gamma ray logging device, a wire, and a computer.

2. The systems of claim 1 wherein the gamma ray logging device comprises:
an open position and a closed position; and
when in the open position, a portion of the gamma ray logging device is in close proximity to an interior wall of a well casing.

3. The system of claim 1 wherein a first end of the wire is in electrical communication with the gamma ray logging device and a second end of the wire is in electrical communication with the computer.

4. The system of claim 1 wherein:
the gamma ray logging device comprises an arm;
said arm, upon activation, moves a portion of the gamma ray logging device towards the inner wall of the casing.

5. The system of claim 1 wherein the gamma ray logging device is off center with respect to the central axis of the well.

6. A method of measuring the level of cement in a well comprising:
lowering a gamma ray logging device into a well via a wire wherein a first end of the wire is in electrical communication with the gamma ray logging device and a second end of the wire is in electrical communication with a computer on the surface;
lowering the gamma ray logging device to a desired depth within the well;
recording the depth of the gamma ray logging devices; and
measuring gamma rays using the gamma ray logging device.

7. The method of claim 6 wherein the gamma ray logging device is placed off center with respect to the central axis of the well.

8. The method of claim 6 further comprising the gamma ray logging device transmitting gamma ray data to the computer.

9. The method of claim 8 further comprising pumping cement into the well.

10. The method of claim 9 further comprising discontinuing pumping of cement into the well when the recorded gamma ray data indicates a spike in gamma rays.

11. The method of claim 10 wherein at the time the gamma ray data indicates a spike in gamma rays, the depth of the cement is determined to be the same depth as the recorded depth of the gamma ray logging device.

12. The method of claim 11 further comprising:
raising the gamma ray logging tool to a second desired depth;
recording the second depth of the gamma ray logging tool;
pumping cement into the well;
discontinuing pumping cement into the well when the gamma ray data indicates a spike in gamma rays;
determining the depth of cement at the time of the gamma ray data indicated a spike in gamma rays to be the same depth as the second depth of the gamma ray logging device.

13. A method for measuring the depth of cement in a well comprising:
lowering a gamma ray logging device into a well via a wire wherein a first end of the wire is in electrical communication with the gamma ray logging device and a second end of the wire is in electrical communication with a computer at the surface of the well;
placing the gamma ray logging device so that the gamma ray logging device is more proximate a side of a casing within the well than the central axis of the well;
lowering the gamma ray logging device to a first desired depth and recording the first desired depth of the gamma ray logging device;
activating an arm of the gamma ray logging device which extends a member of the gamma ray logging device towards the inner wall of the casing and into close proximity with the inner wall of the casing;
activating the gamma ray logging device to begin measuring gamma ray data;
the gamma ray logging device transmitting the gamma ray data to the computer; and
discontinuing pumping cement when the gamma ray data indicates a spike in gamma rays.

14. The method of claim 14 further comprising:
raising the gamma ray device to a second desired depth and recording the second gamma ray device depth;
continuing to record and transmit gamma ray data;
resuming pumping cement into the well;
discontinuing pumping cement into the well when the gamma ray data indicates a spike in gamma rays.

15. The method of claim 15 further comprising repeating the following steps until the pumping of cement is complete:
raising the gamma ray logging device to a new desired depth and recording the new depth;
measuring and transmitting gamma ray data;
pumping cement; and
discontinuing pumping cement when the gamma ray data indicates a spike in gamma rays.
